(19) United States
(12) Patent Application Publication
(10) Pub. No.: US 2009/0058913 A1
(43) Pub. Date: Mar. 5, 2009

(54) INK JET IMAGE FORMING APPARATUS AND METHOD OF CONTROLLING THE SAME

(75) Inventor: Jae Young CHANG, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/114,120

(22) Filed: May 2, 2008

(30) Foreign Application Priority Data
Sep. 3, 2007 (KR) 2007-88987

(51) Int. Cl. B41J 29/38

(52) U.S. Cl. 347/17

(57) ABSTRACT

Temperature characteristic information of each line of a print image is established in a database, an initial value of a temperature sensor is corrected such that a difference between a temperature measured by the temperature sensor provided in a print head and a temperature estimated on the basis of the temperature characteristic information established in the database is in an allowable range, and a printing operation is performed according to the temperature measured by the corrected temperature sensor. Accordingly, it is possible to prevent printing quality from deteriorating due to a measurement error of the temperature sensor.

### CROSS-REFERENCE TO RELATED APPLICATIONS

This application claims the benefit and priority under 35 U.S.C. § 119(a) of Korean Patent Application No. 2007-88987, filed on Sep. 3, 2007 in the Korean Intellectual Property Office, the disclosure of which is incorporated herein by reference in its entirety.

### BACKGROUND OF THE INVENTION

1. Field of the Invention

The present general inventive concept relates to an ink jet image forming apparatus capable of accurately measuring the temperature of a print head, and a method of controlling the same.

2. Description of the Related Art

An ink jet print head used in an ink jet image forming apparatus is a device to eject droplets of ink onto a printing medium at a desired position so as to form an image of a predetermined color. The ink jet print head is generally divided into two types: a thermal driving type and a piezoelectric driving type, according to a mechanism of ejecting the ink droplets. The thermal driving type ink jet print head generates bubbles in the ink contained in an ink chamber using a heater and ejects the ink droplets by the expansion force of the bubbles. The piezoelectric driving type ejects ink droplets using pressure applied to the ink due to mechanical deformation of a piezoelectric material.

A mechanism of ejecting the ink droplets in the thermal driving type ink jet print head will now be described in detail. When pulse-shaped current flows in the heater including a resistance heating element, the heater generates heat such that the ink provided adjacent to the heater is instantly heated to about 300° C. Then, the ink is boiled, the bubbles are generated therein and the generated bubbles expand such that pressure is generated in the ink chamber in which the ink is filled. Accordingly, the ink which exists in the vicinity of a nozzle is ejected from the ink chamber through the nozzle in the form of ink droplets.

The ink ejection amount of the ink jet print head varies according to the temperature of the print head, thereby having influence on printing quality. Accordingly, a temperature sensor is mounted in the print head such that the temperature of the ink of the print head is measured using the temperature sensor.

The temperature sensor mounted in the ink jet print head includes a thermistor manufactured by a general semiconductor process. Since a resistance value of the thermistor varies as the temperature of the print head is increased at the time of a printing operation, the temperature of the print head is calculated by a variation in resistance value of the thermistor, the temperature of the ink is estimated on the basis of the temperature of the print head, and the heater of the nozzle is controlled such that the ink ejection amount is adjusted.

Conventionally, a method of estimating the temperature of the ink depending on the variation in resistance value of the temperature sensor was used. Since the resistance value of the temperature sensor represents a relative indicator of the temperature of the ink, a relationship between the temperature of air existing in the image forming apparatus and the resistance of the temperature sensor should be previously measured in order to directly calculate the temperature of the ink from the resistance value of the temperature sensor. That is, the temperature of the air existing in the ink jet image forming apparatus is measured, an initial value of the temperature sensor in the print head is set on the basis of the temperature of the air, and the temperature of the ink at the time of the printing operation is measured according to the degree that the output of the temperature sensor varies.

Recently, an array type ink jet image forming apparatus using a line printing method of moving only a printing medium in a state in which a print head, including a nozzle unit corresponding to the width of the printing medium, is fixed so as to print an image has been developed.

In the array-type ink jet image forming apparatus, an image is printed in the unit of a line. Due to the characteristics of the line printing method, thermal loads of the nozzles may be different from one another. This is because, if an image to be printed is locally concentrated to a specific region, nozzles corresponding to the specific region continuously and repeatedly perform an ink ejecting operation and nozzles corresponding to a region, in which the image to be printed is not present or the concentration of the image to be printed is low, do not perform the ink ejecting operation or intermittently perform the ink ejecting operation.

Even in a case of printing a page of a document, a difference among the thermal loads of the plurality of nozzles occurs line by line. When the same image is repeatedly printed in great quantities, the difference among the thermal loads of the nozzles is increased.

In the past, the temperature of the print head was measured using the temperature sensor mounted in the print head although the difference among the thermal loads occurs line by line. The measured temperature only represents an average temperature of the print head and is not suitable as temperature information for checking the thermal loads of the nozzles line by line. For example, even when the thermal loads are locally increased at the time of the printing operation, the temperature measured by the temperature sensor may not exceed a reference temperature. In contrast, even when the thermal loads of the nozzles of each line are suitable, the temperature measured by the temperature sensor may exceed the reference temperature and thus the printing operation may be unnecessarily delayed or stopped. If the reliability of the temperature measured by the temperature sensor is decreased, an operation for heating the heater in order to eject the ink through the nozzles is affected. Thus, printing quality deteriorates.

As described above, in the array ink jet image forming apparatus, since the thermal loads of the nozzles are different from one another due to the characteristics of the line printing method, there is a need for a method of accurately measuring the temperature of the print head in consideration that the difference among the thermal loads of the nozzles occurs line by line.

### SUMMARY OF THE INVENTION

The present general inventive concept provides an apparatus and method to accurately measure the temperature of a print head by reducing a measurement error of a temperature sensor at the time of a printing operation.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink jet image forming apparatus including a print head including a temperature sensor, an image processing unit to supply characteristic information of a print image, a database having temperature characteristic information corresponding to the characteristic information of the print image, and a control unit to search the database on the basis of the characteristic information of the print image received from the image processing unit, estimate the temperature of the print head, correct an initial value of the temperature sensor according to a difference between the estimated temperature and a measured temperature of the temperature sensor, and perform a printing operation on the basis of the temperature of the print head measured by the corrected temperature sensor.

The image processing unit may supply information on the number of dots of each page and the number of dots of each line of the print image.

The ink jet image forming apparatus may further include an input unit to input the print image, and the input unit may supply the print image to the image processing unit.

The temperature characteristic information established in the database may include an active profile representing that the temperature of the print head varies with each line to be printed and a passive profile representing that a lower limit temperature of the print head for each corresponding line to be printed of the active profile varies with a time of the printing operation.

The control unit may set a temperature obtained by combining the active profile and the passive profile as the estimated temperature of the print head.

The temperature sensor may measure an average temperature of the print head.

The temperature sensor may be a thermistor which uses a thermal resistance method in which a resistance value varies according to the temperature.

The print head may include a nozzle unit corresponding to the width of the printing medium.

The ink jet image forming apparatus may further include a memory to store the information on the initial value of the temperature sensor corrected by the control unit.

The foregoing and/or other aspects and utilities of the present general inventive concept may also be achieved by providing a method of controlling an ink jet image forming apparatus which performs a printing operation using a temperature measured by a temperature sensor provided in a print head, the method including receiving characteristic information of a print image, estimating the temperature of the print head according to the characteristic information of the print image, determining whether a difference between the estimated temperature of the print head and the temperature measured by the temperature sensor is in a predetermined allowable range, correcting an initial value of the temperature sensor if the difference is out of the allowable range, and performing the printing operation on the basis of the temperature of the print head measured by the corrected temperature sensor.

The characteristic information of the print image may include information on the number of dots of each page and the number of dots of each line of the print image.

The estimating of the temperature of the print head may include searching for an active profile representing that the temperature of the print head varies with each line to be printed and a passive profile representing that a lower limit temperature of the active profile varies with a time of the printing operation, combining the active profile and the passive profile corresponding to the characteristic information of the print image, and estimating the temperature of the print head.

When the initial value of the temperature sensor is corrected, information on the corrected initial value of the temperature sensor may be stored.

The correcting of the initial value of the temperature sensor may be repeated until the allowable range is satisfied.

The foregoing and/or other aspects and utilities of the present general inventive concept may also be achieved by providing a temperature controlled ink jet image forming apparatus including a print head having a temperature sensor to measure a temperature of the print head, an image processor to determine a number of dots of each line of the print image, and a controller to control a printing operation of the print image on a line by line basis based on the measured temperature of the print head and the determined number of dots.

The determined number of dots of each line of the print image may correspond to an estimated temperature of the print head during the printing operation on a line by line basis.

The print head may further include a plurality of nozzles having thermal loading variations which correspond to an active profile of the temperature of the print head on a line by line basis during the printing operation.

The foregoing and/or other aspects and utilities of the present general inventive concept may also be achieved by providing a method of controlling an ink jet image forming apparatus, the method including measuring a temperature of a print head, and performing a printing operation of the print image based on the measured temperature of the print head compared to least one associated temperature profile of the print head which corresponds to varying thermal loads associated with the print head on a line by line basis of the print image during the printing operation.

The performing of the printing operation may further include comparing the measured temperature of the print head and an estimated temperature of the print head associated with the at least one temperature profile on a line by line basis of the print image.

If the comparing results in a temperature difference which is not in a predetermined range, an initial value of a temperature sensor of the print head may be changed.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic diagram illustrating the configuration of an ink jet image forming apparatus according to an embodiment of the present general inventive concept;

FIG. 2 is a view illustrating an arrangement of nozzles which are formed in correspondence with a plurality of colors in a head chip mounted in a print head of the ink jet image forming apparatus according to an embodiment of the present general inventive concept;

FIG. 3 is a view illustrating the structure of a temperature sensor mounted in the head chip mounted in the print head of the ink jet image forming apparatus according to an embodiment of the present general inventive concept;

FIG. 4 is a graph illustrating a variation in temperature according to the characteristics of a print image in the ink jet image forming apparatus according to an embodiment of the present general inventive concept;

FIG. 5 is a graph illustrating an active profile representing a line-by-line variation in the temperature and a passive profile representing a low-limit temperature which varies with a time of a printing operation, when the same image is continuously and repeatedly printed according to the present general inventive concept;

FIG. 6 is a control block diagram of the ink jet image forming apparatus according to an embodiment of the present general inventive concept; and

FIG. 7 is a flowchart illustrating a method of controlling the ink jet image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

Hereinafter, an ink jet image forming apparatus and a method of controlling the same according to an embodiment of the present general inventive concept will be described.

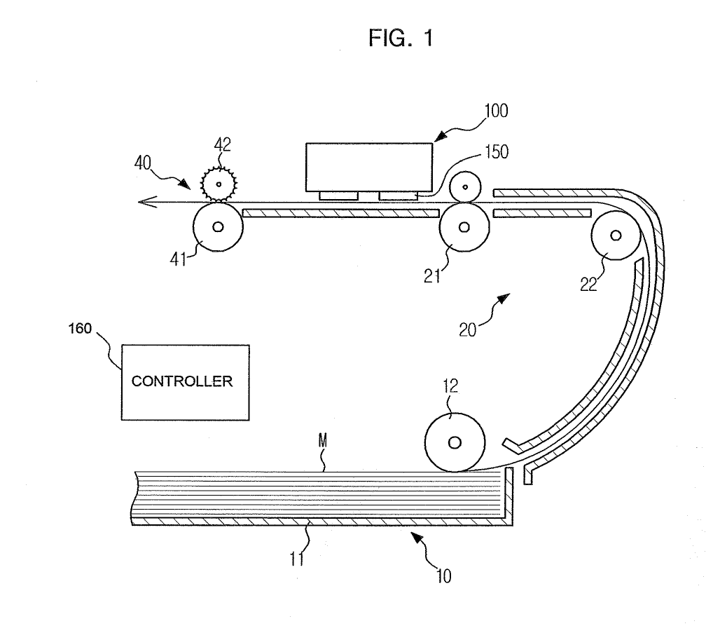

As illustrated in FIG. 1, the ink jet image forming apparatus according to the embodiment of the present general inventive concept includes a feeding unit 10 to feed a printing medium M, a transporting unit 20 to transport the printing medium, a print head 150 to form an image on the printing medium transported by the transporting unit 20, an ink supplying device 100 to supply ink to the print head 150, an ejecting unit 40 to eject the printing medium, on which the image is printed, from the image forming apparatus, and a controller 160 to control printing operations of the image forming apparatus.

The feeding unit 10 includes a feeding tray 11 in which printing medium M is loaded and a pickup roller 12 to pick up the printing medium M loaded in the feeding tray 11 one by one. The transporting unit 20 transports the printing medium M picked up by the pickup roller 12 to the lower side of the print head 150 and includes a feeding roller 21 mounted at the inlet side of the print head 150 and an assistant roller 22 mounted between the feeding roller 21 and the pickup roller 12.

The ejecting unit 40 includes an ejecting roller 41 which is mounted at the downstream side of the print head 150 in a transporting direction of the printing medium M and a star wheel 42 which is mounted so as to face and be in close proximity to the ejecting roller 41. The printing medium M is ejected from the image forming apparatus by the ejecting unit 40 after passing between the ejecting roller 41 and the star wheel 42.

The print head 150 used in the ink jet image forming apparatus includes a nozzle unit corresponding to the width of the printing medium. A method of forming a plurality of nozzles in a single head chip, and a method of arranging a plurality of head chips each having at least one nozzle mounted therein in the sheet width direction (that is, in the direction of the width of the printing medium M), have been developed.

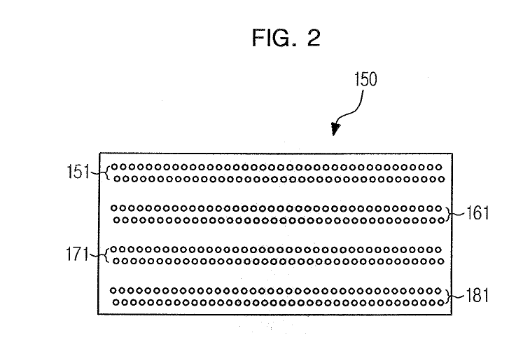

As illustrated in FIG. 2, in an example of the print head 150, odd-numbered nozzles and even-numbered nozzles are arranged in two rows in the sheet width direction for each of a plurality of nozzle groups according to various colors. For example, a first nozzle group 151 is provided in order to eject cyan ink, a second nozzle group 161 is provided in order to eject magenta ink, a third nozzle group 171 is provided in order to eject yellow ink, and a fourth nozzle group 181 is provided in order to eject black ink.

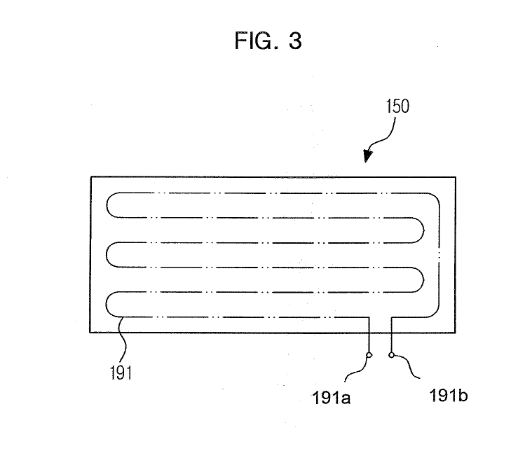

A temperature sensor to measure the temperature of the head may be mounted in the print head 150. As illustrated in FIG. 3, the temperature sensor 191 may be implemented by a thermal resistance type thermistor which is uniformly distributed in the print head such that its resistance varies according to the temperature of the print head. A voltage corresponding to a resistance value measured between first and second ends 191a and 191b of the thermistor temperature sensor 191, which varies according to the temperature of the print head 150, is converted to digital data by an A/D converter (ADC) (not illustrated) and the digital data is supplied to the controller 160.

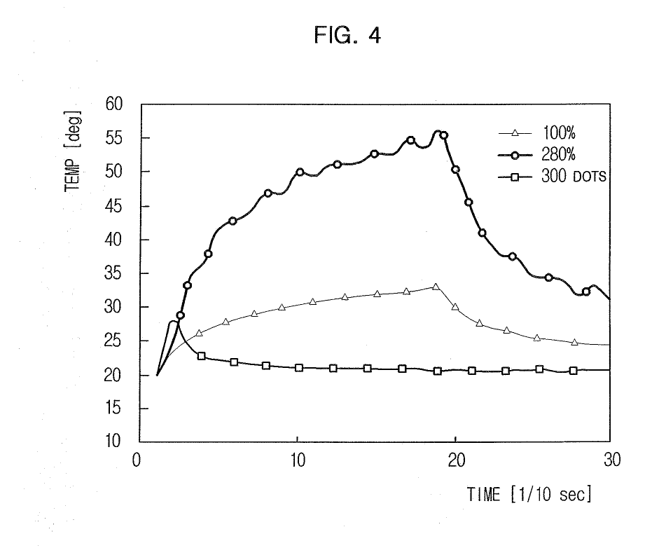

An example of a variation in temperature of the print head 150 according to characteristics of a print image is illustrated in FIG. 4.

Referring to FIG. 4, when ink is ejected through all the nozzles (at 300 dots) of the print head 150 once (as denoted by the 300 dots plot in FIG. 4), it can be seen that the intensities of the thermal loads of all the nozzles of the print head 150 are at their lowest levels.

When the inks of four colors are ejected through 70% of all the nozzles of a nozzle group of a respective color (that is, 70% of the cyan nozzle group 151 nozzles, 70% of the magenta nozzle group 161 nozzles, 70% of the yellow nozzle group 171 nozzles, and 70% of the black nozzle group 181 nozzles) (as denoted by the 280% plot in FIG. 4), it can be seen that the intensities of the thermal loads of all the nozzles of print head 150 are at their highest levels.

When the ink of a single color is ejected through all the nozzles only of the respective nozzle group of the single color (as denoted by the 100% plot in FIG. 4), it can be seen that the intensities of the thermal loads of all the nozzles of print head 150 are intermediate between those of the two above-described cases.

The intensities of the thermal loads of the nozzles of the print head 150 vary according to the characteristics of the print image and are proportional to the number of nozzles used in the printing and a printing time of each line.

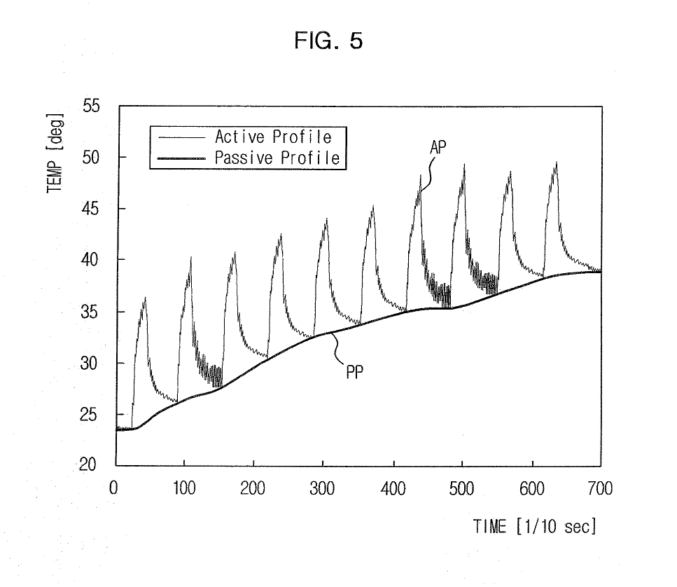

An example of a variation in temperature of the print head 150 when a same image is continuously and repeatedly printed on a printing medium is illustrated in FIG. 5.

Referring to FIG. 5, the variation in measured temperature of the print head 150 is represented by a combination of an active profile curve (denoted “AP”) and a passive profile curve (denoted “PP”). Here, the AP represents that the temperature of the print head 150 is increased/decreased by each line to be printed, and the PP represents that a lower-limit temperature of the print head 150 for each corresponding line is gradually increased with the time of the printing operation. The PP is a curve obtained by connecting the data points representing the lower-limit temperatures of the AP and represents the lower-limit temperatures of the print head 150 for the respective lines being printed.

As can be seen from the graphs illustrated in FIGS. 4 and 5, the difference among the thermal loads applied to the nozzles of the print head 150 occurs due to the characteristics of the print image and are represented by the AP and the PP corresponding to the characteristics of the print image. Accordingly, it is possible to estimate the temperature of the print head 150 by temperature characteristic information related to the AP and the PP.

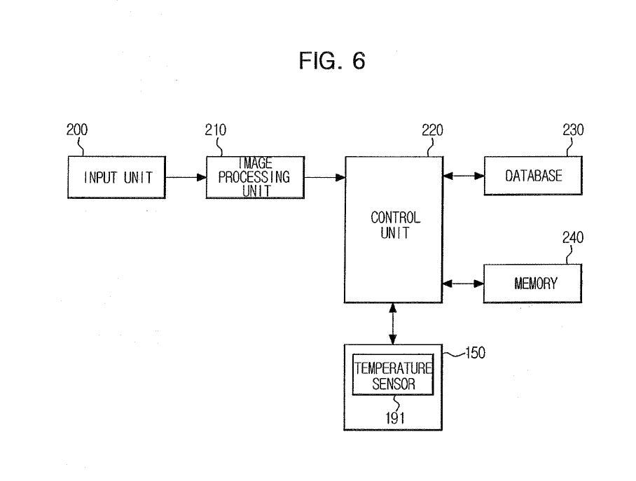

The characteristics of the print image are obtained from information on the number of dots contained in each page or each line of the print image to be printed, and the information on the number of dots can be obtained by an operation to process an input image in an image processing unit 210 (referring to FIG. 6).

Accordingly, the temperature characteristic information related to the AP and the PP according to the characteristics of the print image may be established in a database, as described below, an AP and a PP best matched to the characteristics of the print image obtained by the image processing operation are searched for in the database, and the temperature of the print head 150 may be estimated using the searched for AP and PP.

Since the temperature of the print head 150 is estimated based on the characteristics of the print image, the reliability of the temperature measured by the temperature sensor 191 can be verified. For example, if a difference between the temperature of the print head 150 estimated according to the characteristics of the print image and an average temperature of the print head 150 measured by the temperature sensor 191 exceeds an allowable range, it is determined that an initial value of the temperature sensor 191 has been erroneously set and the initial value of the temperature sensor 191 is corrected. Accordingly, the temperature of the print head 150 can be accurately measured using the temperature sensor 191 having the corrected initial value.

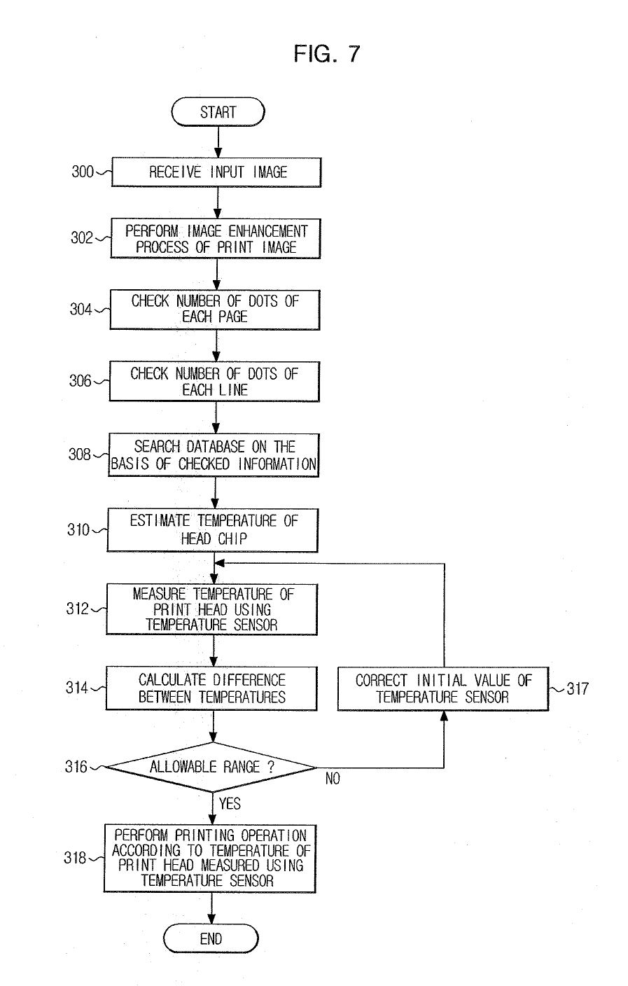

FIG. 6 is a control block diagram of the ink jet image forming apparatus according to an embodiment of the present general inventive concept, and FIG. 7 is a flowchart illustrating a method of controlling the ink jet image forming apparatus according to an embodiment of the present general inventive concept.

An input unit 200 receives and supplies a print image to an image processing unit 210. The input unit may receive an image from an external device (not illustrated), for example an image scanned by a scanner or a print image provided from a personal computer.

The image processing unit 210, which may include an image processor, performs an image enhancement process for example, to make characters of the received image clear and/or to process a background image.

The image processing unit 210 supplies the number of dots of each page or the number of dots of each line to be printed to a control unit 220 as characteristic information of the print image.

The control unit 220, which may include the controller 160 (referring to FIG. 1), searches a database 230, which may be stored in a memory 240, or in a memory of an external memory device (not illustrated), on the basis of the characteristic information of the print image received from the image processing unit 210, finds an AP and a PP best matched to the characteristic information of the print image, and estimates the temperature of the print head 150 using the best matched AP and PP.

The control unit 220 supplies a print control signal to the print head 150 to print the print image such that a heater (not illustrated) is driven and ink is ejected through the nozzles onto a printing medium so as to perform a printing operation. The control unit 220 receives the temperature measured by the temperature sensor 191 while the printing operation is performed.

The control unit 220 compares the temperature of the print head 150 estimated on the basis of the characteristics of the print image with the temperature measured by the temperature sensor 191 and performs the printing operation on the basis of the measured temperature if the difference between the temperatures is in a predetermined allowable range. In contrast, if the difference between the temperatures is out of the allowable range, the control unit 220 corrects the initial value of the temperature sensor 191 (that is, the estimated temperature of the print head 150) and repeats the measurement of the temperature of the print head 150 using the temperature sensor 191 and the comparison of the difference between the temperatures. If the initial value of the temperature sensor 191 is adequately corrected by the repeated operation, the control unit 220 stores information on the corrected initial value of the temperature sensor in the memory 240.

A method of controlling the ink jet image forming apparatus according to an embodiment of present general inventive concept will be described with reference to FIG. 7.

When power is supplied to the image forming apparatus, the input unit 220 receives the print image from an external device, which may be, for example, a scanner or a personal computer (not illustrated) (operation 300).

Then, the image processing unit 210 performs an image enhancement process on the print image (operation 302), checks the number of dots of each page and the number of dots of each line to be printed as the characteristic information of the print image, and supplies the information to the control unit 220 (operations 304 and 306).

Then, the control unit 220 searches for best matched AP and PP information established in the database 230 on the basis of the received information from the image processing unit (operation 308) and estimates the temperature of the print head 150 (that is, of a head chip disposed thereon, not illustrated) using the AP and the PP best matched to the characteristic information of the print image (operation 310).

Then, the control unit 220 receives the temperature of the print head 150 measured by the temperature sensor 191 (operation 312) and calculates a difference between the measured temperature of the temperature sensor and the estimated temperature (operation 314).

Then, the control unit 220 determines whether the calculated difference is in a predetermined allowable range (operation 316), corrects the initial value of the temperature sensor 191 if it is determined that the difference is out of the allowable range (operation 317), and progresses to operation 312 in order to repeat the operation to compare the measured temperature with the estimated temperature.

When it is determined that the difference is in the allowable range in operation 316, the control unit 220 performs the printing operation on the basis of the temperature of the print head 150 measured by the temperature sensor 191 (operation 318).

As described above, according to the present embodiment, it is possible to apply the characteristics of the print image to an average temperature of the print head measured by the temperature sensor, accurately measure the temperature of the print head which varies with the time of the printing operation, and prevent printing quality from deteriorating due to a temperature measurement error of the temperature sensor.

Also as described above, according to the present general inventive concept, a temperature is estimated according to characteristics of each line of a print image to be printed and is compared with a measured temperature. If a difference between the estimated temperature and the measured temperature is out of a predetermined allowable range, an initial value of the temperature sensor is corrected such that a difference between an actual temperature and the temperature measured by the temperature sensor is reduced. It is thereby possible to more accurately measure the temperature of the print head and prevent printing quality from deteriorating.

Although a few embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An ink jet image forming apparatus, comprising:
a print head including a temperature sensor;
an image processing unit to supply characteristic information of a print image;
a database having temperature characteristic information corresponding to the characteristic information of the print image; and
a control unit to search the database on the basis of the characteristic information of the print image received from the image processing unit, estimate the temperature of the print head, correct an initial value of the temperature sensor according to a difference between the estimated temperature and a measured temperature of the temperature sensor, and perform a printing operation on the basis of the temperature of the print head measured by the corrected temperature sensor.

2. The ink jet image forming apparatus according to claim 1, wherein the image processing unit supplies information on the number of dots of each page and the number of dots of each line of the print image.

3. The ink jet image forming apparatus according to claim 1, further comprising:
an input unit to receive the print image, wherein the input unit supplies the print image to the image processing unit.

4. The ink jet image forming apparatus according to claim 1, wherein the temperature characteristic information established in the database includes an active profile representing that the temperature of the print head varies with each line to be printed and a passive profile representing that a lower limit temperature of the print head for each corresponding line to be printed of the active profile varies with a time of the printing operation.

5. The ink jet image forming apparatus according to claim 4, wherein the control unit sets a temperature obtained by combining the active profile and the passive profile as the estimated temperature of the print head.

6. The ink jet image forming apparatus according to claim 1, wherein the temperature sensor measures an average temperature of the print head.

7. The ink jet image forming apparatus according to claim 6, wherein the temperature sensor is a thermistor which uses a thermal resistance method in which a resistance value varies according to the temperature.

8. The ink jet image forming apparatus according to claim 1, wherein the print head includes a nozzle unit corresponding to the width of a printing medium.

9. The ink jet image forming apparatus according to claim 1, further comprising:
a memory to store the information on the initial value of the temperature sensor corrected by the control unit.

10. A method of controlling an ink jet image forming apparatus which performs a printing operation using a temperature measured by a temperature sensor provided in a print head, the method comprising:
receiving characteristic information of a print image;
estimating the temperature of the print head according to the characteristic information of the print image;
determining whether a difference between the estimated temperature of the print head and the temperature measured by the temperature sensor is in a predetermined allowable range;
correcting an initial value of the temperature sensor if the difference is out of the allowable range; and
performing the printing operation on the basis of the temperature of the print head measured by the corrected temperature sensor.

11. The method according to claim 10, wherein the characteristic information of the print image includes information on the number of dots of each page and the number of dots of each line of the print image.

12. The method according to claim 10, wherein the estimating of the temperature of the print head comprises:
searching for an active profile representing that the temperature of the print head varies with each line to be printed and a passive profile representing that a lower limit temperature of the active profile varies with a time of the printing operation,
combining the active profile and the passive profile corresponding to the characteristic information of the print image, and
estimating the temperature of the print head.

13. The method according to claim 10, wherein, when the initial value of the temperature sensor is corrected, information on the corrected initial value of the temperature sensor is stored.

14. The method according to claim 10, wherein the correcting of the initial value of the temperature sensor is repeated until the allowable range is satisfied.

15. A temperature controlled ink jet image forming apparatus, comprising:
a print head having a temperature sensor to measure a temperature of the print head;
an image processor to determine a number of dots of each line of a print image; and
a controller to control a printing operation of the print image on a line by line basis based on the measured temperature of the print head and the determined number of dots.

16. The image forming apparatus of claim 15, wherein the determined number of dots of each line of the print image corresponds to an estimated temperature of the print head during the printing operation on a line by line basis.

17. The image forming apparatus of claim 15, wherein the print head further comprises:
a plurality of nozzles having thermal loading variations which correspond to an active profile of the temperature of the print head on a line by line basis during the printing operation.

18. A method of controlling an ink jet image forming apparatus, the method comprising:
measuring a temperature of a print head; and
performing a printing operation of a print image based on the measured temperature of the print head compared to least one associated temperature profile of the print head which corresponds to varying thermal loads associated with the print head on a line by line basis of the print image during the printing operation.

19. The method of claim 18, wherein the performing of the printing operation further comprises:
comparing the measured temperature of the print head and an estimated temperature of the print head associated with the at least one temperature profile on a line by line basis of the print image.

20. The method of claim 19, wherein if the comparing results in a temperature difference which is not in a predetermined range, an initial value of a temperature sensor of the print head is changed.
